(19) United States
(12) Patent Application Publication
(10) Pub. No.: US 2025/0069068 A1
(43) Pub. Date: Feb. 27, 2025

(54) PROCESSING SYSTEM, METHOD FOR OBTAINING USING PERMISSION, AND SMART TERMINAL BASED ON GENERATIVE ARTIFICIAL INTELLIGENCE LARGE LANGUAGE MODEL

(71) Applicant: SOLOS TECHNOLOGY (SHENZHEN) LIMITED, Shenzhen (CN)

(72) Inventors: Chi Sum Yu, Shenzhen (CN); Yat Shing Mok, Shenzhen (CN); Kenneth Fan, Shenzhen (CN); Wai Kuen Cheung, Shenzhen (CN)

(21) Appl. No.: 18/370,388

(22) Filed: Sep. 19, 2023

(30) Foreign Application Priority Data
Aug. 24, 2023 (CN) 202311083681.8

(51) Int. Cl. G06Q 20/38; G06F 21/10; G06N 3/0455; G06N 3/0475; G06Q 30/0241; G10L 15/22

(52) U.S. Cl. CPC G06Q 20/382; G06F 21/1015; G06N 3/0455; G06N 3/0475; G06Q 30/0277; G10L 15/22; G10L 2015/223

(57) ABSTRACT

A processing system, a method for obtaining using permission and a smart terminal based on generative artificial intelligence large language model (GAILLM) are provided. The processing system includes a smart terminal used to: when a request for using a GAILLM service of a user is obtained, determine whether the user has a permission to use the GAILLM service according to subscription information corresponding to identity of smart glasses of the user, allow the user to use the GAILLM service when the user has the permission, and output a notification message to notify the user to obtain the permission by performing a preset action when the user does not have the permission. The application improves the convenience of obtaining the permission to use the GAILLM service.

### CROSS REFERENCE TO RELATED APPLICATIONS

This application claims priority to Chinese Patent Application No. 202311083681.8, filed Aug. 24, 2023, which is hereby incorporated by reference herein as if set forth in its entirety.

### BACKGROUND

### 1. Technical Field

The present disclosure generally relates to the technical field of smart glasses, and particularly to a processing system, a method for obtaining using permission and a smart terminal based on generative artificial intelligence large language model.

### 2. Description of Related Art

With the development of computer technology, users can obtain the service permissions of various computer programs through a computer equipment with the help of the network. However, the current way to obtain various service permissions is usually limited to the users through applications on the smart terminals such as mobile phones. The obtaining process of the service permissions is more cumbersome, and the current way to obtain the service permissions is not convenient enough, which affects the speed and efficiency of obtaining the service permissions.

### SUMMARY

The embodiments of the present disclosure provide a processing system based on a generative artificial intelligence large language model (GAILLM), a method for obtaining a using permission of the GAILLM, and a smart terminal, which aim to conveniently obtain a permission to use the GAILLM service.

An embodiment of the present disclosure provides a processing system based on a GAILLM, including a smart terminal used to: when a request for using a GAILLM service of a user is obtained, determine whether the user has a permission to use the GAILLM service according to subscription information corresponding to identity information of smart glasses of the user;
in response to the user having the permission, allow the user to use the GAILLM service; and
in response to the user not having the permission, output a notification message to notify the user to obtain the permission by performing a preset action.

An embodiment of the present disclosure further provides a smart terminal including: a non-transitory memory; a processor; and one or more computer programs stored in the non-transitory memory and executable on the processor, wherein the one or more computer programs include instructions to:
when a request for using a GAILLM service of a user is obtained, determine whether the user has a permission to use the GAILLM service according to subscription information corresponding to identity information of smart glasses of the user;
in response to the user having the permission, allow the user to use the GAILLM service; and
in response to the user not having the permission, output a notification message to notify the user to obtain the permission by performing a preset action.

An embodiment of the present disclosure further provides a computer-implemented method for obtaining a using permission of a GAILLM, including:
when a request for using a GAILLM service of a user is obtained, determining whether the user has a permission to use the GAILLM service according to subscription information corresponding to identity information of smart glasses of the user;
in response to the user having the permission, allowing the user to use the GAILLM service; and
in response to the user not having the permission, outputting a notification message to notify the user to obtain the permission by performing a preset action.

In each embodiment of the present application, the processing system based on the GAILLM(s) is used to determine whether a user has a permission to use a GAILLM service according to subscription information corresponding to identity information of smart glasses of the user when a request for using the GAILLM service of the user is obtained, allow the user to use the GAILLM service when the user has the permission, and notify the user to obtain the permission by performing a preset action when the user does not have the permission. Accordingly, when a user requests to use the GAILLM service, the subscription status of the user to the GAILLM service can be quickly determined through the identity information of the smart glasses of the user, and a permission to use the GAILLM service is provided to the user or an obtaining manner of the permission is notified to the user according to the determining result, and thereby improving the convenience of providing the GAILLM service to the user, and improving the speed and efficiency of obtaining the service permission.

### BRIEF DESCRIPTION OF THE DRAWINGS

In order to more clearly illustrate the technical solutions in this embodiment, the drawings used in the embodiments or the description of the prior art will be briefly introduced below. It should be understood that, the drawings in the following description are only examples of the present disclosure. For those skilled in the art, other drawings can be obtained based on these drawings without creative works.

FIG. 1 is a schematic structural diagram of a processing system based on a generative artificial intelligence large language model (GAILLM) according to one embodiment of the present disclosure;

FIG. 2 is a schematic diagram of module structure of smart glasses in the processing system based on the GAILLM according to one embodiment of the present disclosure;

FIG. 3 is a schematic diagram of an external structure of the smart glasses based on FIG. 2;

FIG. 4 is a flow diagram of a user purchasing a permission to use a GAILLM service through a smart terminal of the processing system based on the GAILLM according to one embodiment of the present disclosure;

FIG. 5 is a flow diagram of the user purchasing the permission to use the GAILLM service through the smart terminal of the processing system based on the GAILLM according to another embodiment of the present disclosure;

FIG. 6 is a flow diagram of obtaining an advertising content through the processing system based on the GAILLM according to one embodiment of the present disclosure;

FIG. 7 is a flow diagram of obtaining the advertising content through the processing system based on the GAILLM according to another embodiment of the present disclosure;

FIG. 8 is a flow diagram of a method for obtaining a using permission of the GAILLM according to one embodiment of the present disclosure.

### DETAILED DESCRIPTION

In order to make the objects, features and advantages of the present disclosure more obvious and easier to understand, the technical solutions in this embodiment will be clearly and completely described below with reference to the drawings. Apparently, the described embodiments are part of the embodiments of the present disclosure, not all of the embodiments. All other embodiments obtained by those skilled in the art based on the embodiments of the present disclosure without creative efforts are within the scope of the present disclosure.

In the following descriptions, the terms “including”, “comprising”, “having” and their cognates that are used in the embodiments of the present disclosure are only intended to represent specific features, numbers, steps, operations, elements, components, or combinations of the foregoing items, and should not be understood as excluding the possibilities of the existence of one or more other features, numbers, steps, operations, elements, components or combinations of the foregoing items or adding one or more features, numbers, steps, operations, elements, components or combinations of the foregoing items.

In addition, in the present disclosure, the terms “first”, “second”, “third”, and the like are only used for distinguishing, and cannot be understood as indicating or implying relative importance.

Unless otherwise defined, all terms (including technical and scientific terms) used herein have the same meanings as commonly understood by those skilled in the art to which the embodiments of the present disclosure belong. The terms (e.g., the terms those defined in commonly used dictionaries) will be interpreted as having the same meaning as the contextual meaning in the relevant technology and will not be interpreted as having idealized or overly formal meanings, unless clearly defined in the embodiments of the present disclosure.

An embodiment of the present disclosure provides a processing system based on a generative artificial intelligence large language model (GAILLM), the processing system is used to: when a request for using a GAILLM service of a user is obtained, determine whether the user has a permission to use the GAILLM service according to subscription information corresponding to identity information of smart glasses of the user; in response to the user having the permission to use the GAILLM service, allow the user to use the GAILLM service; and in response to the user not having the permission to use the GAILLM service, notify the user to obtain the permission to use the GAILLM service by performing a preset action.

The identity information of the smart glasses may be a unique ID (Identity), the form of the identity information may be numbers, letters, or other marking information that can uniquely identify the smart glasses, and may be set before the smart glasses leave the factory, or may be customized by the user.

The subscription information refers to the information related to the user subscribing to the GAILLM service, which corresponds to the identity information of the smart glasses.

The processing system may include smart glasses and a smart terminal connected to the smart glasses, and the GAILLM is set in the smart terminal.

The processing system may further include a cloud server connected to the smart terminal, and the GAILLM may be set in the cloud server or the smart terminal.

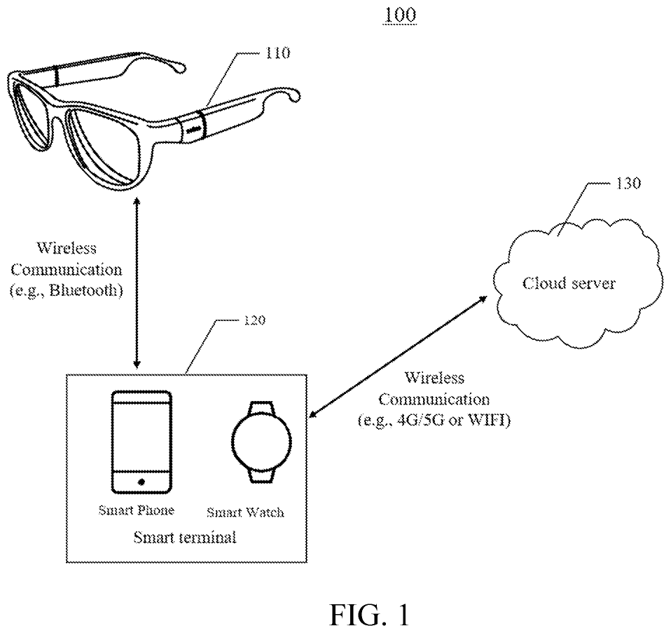

Referring to FIG. 1, FIG. 1 is a schematic structural diagram of the processing system based on the GAILLM according to one embodiment of the present disclosure. As an example, the processing system in FIG. 1 includes smart glasses, a smart terminal and a cloud server. As shown in FIG. 1, the processing system 100 comprises: smart glasses 110, a smart terminal 120 and a cloud server 130. The smart terminal 120 is, for example, a smart phone or smart watch.

The smart glasses 110 is connected to the smart terminal 120, and the smart terminal 120 is connected to the cloud server 130. The smart terminal 120 is installed with an application (App) for wireless communication with the smart glasses 110 through e.g., Bluetooth. Optionally, the smart glasses 110 communicate wirelessly with the smart terminal 120 through e.g., Bluetooth. The smart terminal 120 communicates wirelessly with the cloud server 130 through, for example, 4G or 5G cellular network or WiFi.

Specifically, the smart terminal 120 is used to: when the request for using the GAILLM service of the user is obtained, determine whether the user has the permission to use the GAILLM service according to the subscription information corresponding to the identity information of the smart glasses 110 of the user; allow the user to use the GAILLM service in response to the user having the permission. The smart terminal 120 obtains a service content of the GAILLM corresponding to the request for using the GAILLM service of the user from the GAILLM in the smart terminal 120 or the GAILLM in the cloud server 130, and displays the service content on the smart terminal 120, or sends the service content to the smart glasses 110 for playback. The smart terminal 120 is further used to display a notification message or send the notification message to the smart glasses 110 for playback in response to the user not having the permission, so as to notify the user to obtain the permission by performing a preset action.

Use of the GAILLM Service includes, but is not limited to, when making chat applications or speech command personal assistant applications, requesting to GAILLM and obtaining the service content.

The preset action may be purchasing the permission for using the GAILLM service, or listening to an advertising content. When the user is a new user, that is, a user who requests to use the GAILLM service for the first time, the new user can also be assigned a certain permission to use the GAILLM service, and after the certain permission is exhausted, the permission can be obtained by the above-mentioned actions of purchasing the permission or listening to the advertising content.

The smart terminal may include, but is not limited to: a cellular phone, a smart phone, other wireless communication devices, a personal digital assistant, an audio player, other media players, a music recorder, a video recorder, camera, other media recorders, a smart radio, a Laptop computer, a personal digital assistant (PDA), a portable multimedia player (PMP), a Moving Picture Experts Group (MPEG-1 or MPEG-2) audio layer 3 (MP3) player, a digital camera, and a smart wearable device (such as smart watch, smart bracelet, etc.), a computer. An Android or iOS or other operating systems are further installed on the smart terminal.

The cloud server may be a single server or a distributed server cluster consisting of multiple servers.

The GAILLM may be, but is not limited to: ChatGPT of Open AI, Bard of Google, and other models with similar functions. The GAILLM is trained with a large number of semantics and corresponding task execution commands as samples.

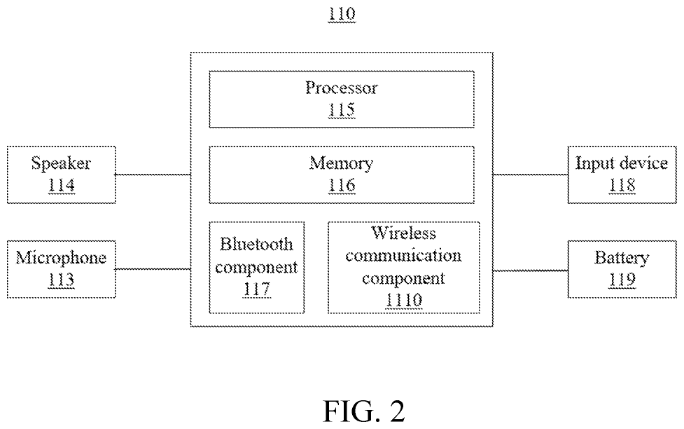

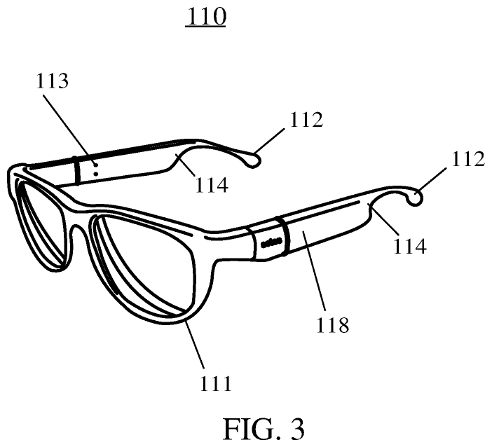

Referring to FIG. 2 and FIG. 3, FIG. 2 is a schematic diagram of module structure of smart glasses in the processing system based on the GAILLM according to one embodiment of the present disclosure, and FIG. 3 is a schematic diagram of an external structure of the smart glasses based on FIG. 2.

The smart glasses 110 may, but are not limited to: a front frame 111, at least one temple 112, at least one microphone 113, at least one speaker 114, at least one processor 115, at least one memory 116, a Bluetooth component 117, an input device 118, and a battery 119.

The front frame 111 may be, for example, a front frame with a lens (e.g., a sunglass lens, a clear lens, or a corrective lens). The at least one temple may include, for example, a right temple 112B and a left temple 112A.

The temple 112 can be fixed or detachably connected to the front frame 111.

The processor 115 is electrically connected to the microphone 113, the speaker 114, the memory 116, the Bluetooth component 117, the input device 118 and the battery 119. The battery 119 is electrically connected to the microphone 113, the speaker 114, the memory 116, the Bluetooth component 117 and the input device 118. The microphone 113, the speaker 114, the processor 115, the memory 116, the Bluetooth component 117, the input device 118 and the battery 119 are disposed on the at least one temple 112 and/or the front frame 111.

The processor 115 may include an MCU (Microcontroller Unit), or the processor 115 may include the MCU and a DSP (Digital Signal Processing). The DSP is used to process the voice data obtained by the microphone 103.

The memory 116 is a non-transitory memory, and specifically may include: a RAM (Random Access Memory) and a flash memory component. One or more programs executable by the processor are stored in the memory 116, and the one or more programs include a plurality of instructions. The instructions are used to receive voice message(s) and play voice message(s).

The Bluetooth component 117 includes a Bluetooth signal transceiver and surrounding circuits. The Bluetooth component can be linked with smart mobile terminals such as smartphones or smart watches, to take phone calls, and music and data communications.

The input device 118 includes a touch sensor or a button. The button includes at least one physical button and/or at least one touch sensor based virtual button. Optionally, the button may be a power-on button on the smart glasses.

Optionally, in another embodiment of the present disclosure, the smart glasses 110 further include a wireless communication component 1110 electrically connected to the processor 115. The wireless communication component 1110 includes a wireless signal transceiver and peripheral circuits, which can be specifically arranged in the inner cavity of the front frame 111 and/or the at least one temple 112. The wireless signal transceiver can, but is not limited to, use at least one of the WiFi (Wireless Fidelity) protocol, the NFC (Near Field Communication) protocol, the ZigBee protocol, the UWB (Ultra-Wide Band) protocol, the RFID (Radio Frequency Identification) protocol, and the cellular mobile communication protocol (such as 3G/4G/5G, etc.) to perform the data transmission, and of course, the wireless communication component 1110 can also be omitted.

Optionally, in another embodiment of the present disclosure, the smart glasses 110 further include an IMU (Inertial Measurement Unit) sensor connected to the processor 115.

Optionally, in another embodiment of the present disclosure, the smart glasses 110 further include an LED light connected to the processor 115, the smart glasses 110 may use the LED light to indicate the working state of the smart glasses, the working state includes: shutdown, power on, and a state corresponding to an operation being performed, etc.

Optionally, in another embodiment of the present disclosure, the smart glasses 110 further comprise a voice biometric recognition module connected to the processor 115 for identifying the speech of the user by the speech print.

Optionally, in another embodiment of the present disclosure, the smart glasses 110 further include a camera connected to the processor 115 for capturing images.

In the embodiments of the present application, the processing system based on the GAILLM(s) is used to determine whether a user has a permission to use a GAILLM service according to subscription information corresponding to identity information of smart glasses of the user when a request for using the GAILLM service of the user is obtained, allow the user to use the GAILLM service when the user has the permission, and notify the user to obtain the permission by performing a preset action when the user does not has the permission. Accordingly, when a user requests to use the GAILLM service, the subscription status of the user to the GAILLM service can be quickly determined through the identity information of the smart glasses of the user, and a permission to use the GAILLM service is provided to the user or a obtaining manner of the permission is notified to the user according to the determining result, and thereby improving the convenience of providing the GAILLM service to the user, and improving the speed and efficiency of obtaining the service permission.

Optionally, in another embodiment of the present disclosure, the processing system 100 is used to: configure free credits with a preset amount or a preset using period for an identity of smart glasses using the GAILLM for the first time, and play a subscription service notification speech and/or a waiting voice notification when an amount of the free credits is less than a preset value or the free credits are expired.

The subscription service notification speech is used to notify the user to obtain the permission by purchasing a paid subscription, and the waiting voice notification is used to remind the user to wait for a next preset configuration cycle to obtain free credits for the next preset configuration cycle.

The GAILLM may be set on the smart terminal 120 or the cloud server.

Optionally, in another embodiment of the present disclosure, the GAILLM is set on the smart terminal 120, the smart terminal 120 is used to: obtain a subscription operation instruction entered by the user through the UI interface, request the service content from the GAILLM, and display the service content to the user. Alternatively, the smart terminal 120 is used to: obtain a speech sent by the user through the smart glasses 110, parse the speech, and when the speech includes the subscription operation instruction, request the service content from the GAILLM and display the service content to the user.

Optionally, in another embodiment of the present disclosure, the GAILLM is set on a cloud server. The user can directly operate the user interface (UI) of an APP or browser built in the smart terminal 120 to complete the subscription to the GAILLM service, and communicate with the subscription server through the APP or browser. The smart terminal 120 may display the prompt information during the subscription process and the content of the GAILLM service obtained after successful subscription by text or speech.

Specifically, the smart terminal 120 is used to play a subscription service notification speech, and the subscription service notification speech is used to notify the user to obtain the permission to use the GAILLM service by purchasing a paid subscription. The smart terminal 120 is further used to: play a notification speech for listening to an advertisement, and the notification speech for listening to the advertisement is used to notify the user to obtain the permission to use the GAILLM service for free by listening to an advertising content.

Optionally, in another embodiment of the present disclosure, the GAILLM is set on a cloud server. The user can directly operate the user interface (UI) of an APP or browser built in the smart terminal 120 to complete the subscription to the GAILLM service, and communicate with the subscription server through the APP or browser. The user may further speak a voice subscription instruction to the smart glasses 110, the smart glasses 110 converts the voice instruction into a subscription command and sends the subscription command to the smart terminal 120, so as to control the smart terminal 120 to complete the subscription to the GAILLM service, and communicate with the subscription server through the APP. The smart terminal 120 plays the prompt information during the subscription process and the content of the GAILLM service obtained after successful subscription through the smart glasses 110 using the voice.

Specifically, the smart terminal 120 is used to forward the subscription service notification speech to the smart glasses 110, and the subscription service notification speech is used to notify the user to obtain the permission to use the GAILLM service by purchasing a paid subscription. Alternatively, the smart terminal 120 is used to forward the notification speech for listening to an advertisement to the smart glasses 110, and the notification speech for listening to the advertisement is used to notify the user to obtain the permission to use the GAILLM service for free by listening to an advertising content. The smart glasses 110 are used to play the subscription service notification speech or the notification speech for listening to the advertisement.

Optionally, in another embodiment of the present disclosure, the user subscribes to a service using natural language through the smart glasses 110. Specifically, the smart glasses 110 are used to obtain the voice subscription instruction of the user, and send a subscription service request to the smart terminal 120 according to the voice subscription instruction. The smart terminal is used to request a subscription for using the GAILLM service according to the subscription service request.

Specifically, the smart terminal 120 may request a subscription to the subscription server. The subscription server is set up on the cloud server, and the GAILLM may be set on the subscription server or other servers in the cloud.

Optionally, in another embodiment of the present disclosure, when the subscription server determines that the permission of the user to use the GAILLM service is about to be exhausted, the subscription server notifies the user to renew one's subscription. Specifically, the subscription server is used to send a permission reminder message to the smart terminal 120, and the permission reminder message is used to remind the user that the permission to use the GAILLM service is about to be exhausted. The smart terminal 120 is used to send the permission reminder message to the smart glasses 110, and the smart glasses 110 play the permission reminder message by the voice.

Optionally, in another embodiment of the present disclosure, the smart terminal 120 is used to: determine whether the user is requesting the GAILLM service for the first time by detecting an identity of the smart glasses of the user;
when the user is requesting the GAILLM service for the first time, determine whether the user is never subscribed to the GAILLM service, send the notification speech for listening to the advertisement to the smart glasses 110 for playback when the user is never subscribed to the GAILLM service, send the advertising content to the smart glasses 110 for playback in response to an action of the user to confirm to listen to an advertisement being detected, and send the subscription service notification speech to the smart glasses 110 for playback in response to an action of the user to refuse to listen to the advertisement being detected; and
when the user is not requesting the GAILLM service for the first time, determine whether the user is never subscribed to the GAILLM service or whether a permission of the subscribed GAILLM service is exhausted, and send the subscription service notification speech to the smart glasses 110 for playback when the user is never subscribed to the GAILLM service or the permission of the subscribed GAILLM service is exhausted.

Optionally, in another embodiment of the present disclosure, the cloud server further includes a subscription information storage server.

The smart glasses 110 are used to obtain a speech of the user, and forward the speech to the smart terminal 120.

The smart terminal 120 is used to: parse the speech, and obtain subscription plan information and purchase subscription credits from the subscription server when the speech includes a subscription operation instruction, and after the purchase is successful, send purchase subscription information to the subscription information storage server for storage, or store the purchase subscription information in the smart terminal.

The subscription credits may be purchased through the APP of the smart terminal 120. Optionally, in another embodiment of the present disclosure, the subscription server includes a first subscription server.

The smart terminal 120 is further used to: obtain the subscription plan information from the first subscription server through an application program or a browser of the smart terminal, and display the subscription plan information to the user; and
obtain target subscription plan information selected by the user, and purchase the subscription credits according to the target subscription plan information.

Optionally, in another embodiment of the present disclosure, the subscription server further includes a second subscription server.

The smart terminal 120 is further used to send the purchase subscription information to the second subscription server through the application program.

The second subscription server is used to: verify validity of the purchase to the first subscription server according to the purchase subscription information, determine that the purchase is successful when the verification is passed, send the purchase subscription information to the subscription information storage server or the smart terminal 120 for storage, and send updating information of the subscription credits to the application program of the smart terminal 120.

Optionally, in another embodiment of the present disclosure, the subscription credits may be purchased through the browser of the smart terminal 120, and the cloud server further includes a payment server.

The smart terminal 120 is further used to: send the purchase subscription information to the payment server through the browser, so that the payment server verifies whether the purchase is successful, determines that the purchase is successful when the verification is passed, and sends the purchase subscription information to the subscription information storage server or the smart terminal 120 for storage.

Optionally, in another embodiment of the present disclosure, the smart terminal 120 is further used to: obtain a service request sent by the user through the smart glasses 110, and send a service request to the subscription information storage server to trigger the subscription information storage server to request a service content from the GAILLM, receive the service content returned by the subscription information storage server, and display the service content to the user.

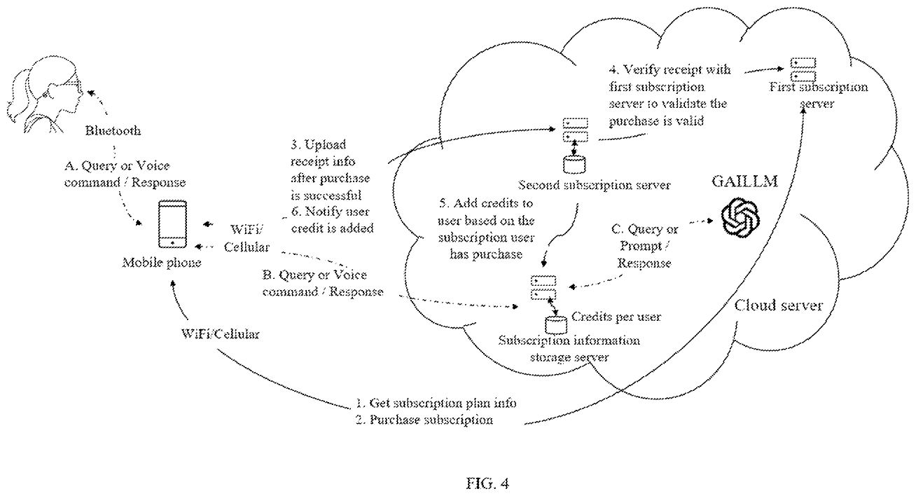

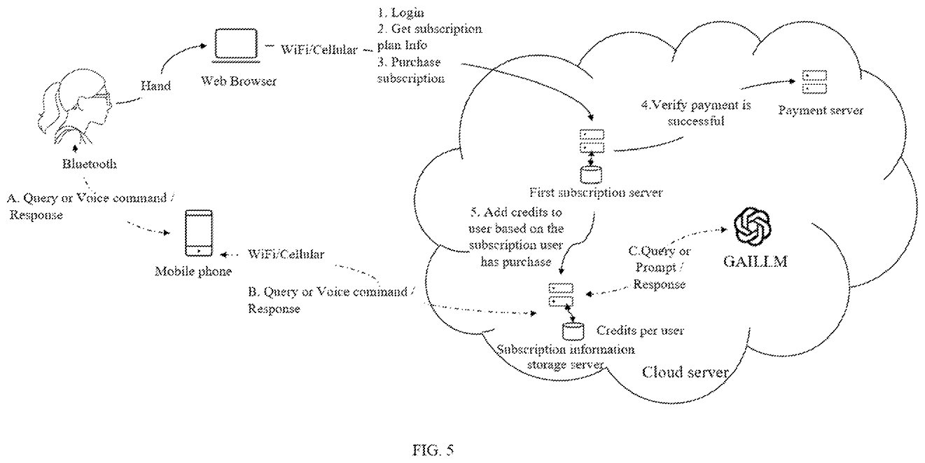

Specifically, refer to FIG. 4 and FIG. 5, FIG. 4 is a flow diagram of the user purchasing the permission to use the GAILLM service through the APP in the smart terminal, and FIG. 5 is a flow diagram of the user purchasing the permission to use the GAILLM service through the browser in the smart terminal. The user wears the smart glasses, which are connected to a smart phone through the Bluetooth. The mobile phone determines that the user does not have the permission to use the GAILLM service according to the subscription information corresponding to the identity information of the smart glasses, that is, the user is neither a new user using the service for the first time, nor has enough credit points to use the service, then the user can purchase a paid subscription to use the GAILLM service through the APP or browser in the smart phone.

As an example, FIG. 4 shows a user subscribing to the GAILLM service through the APP. The user speaks a voice subscription instruction to subscribe to the GAILLM service, and the smart glasses 110 send the voice subscription instruction to the mobile phone. The mobile phone parses the speech subscription instruction, and obtains the subscription operation instruction contained in the speech. The mobile phone is connected to the first subscription server through the WiFi/cellular network. The mobile phone obtains the subscription plan information from the first subscription server through the APP, and displays the subscription plan information to the user by speech playback or displaying a text on the UI interface, so that the user selects a subscription plan. The subscription plan includes: a subscription duration, subscription credits, subscription items, etc. The mobile phone obtains the information of the target subscription plan selected by the user through the voice or UI interface, and purchases the subscription credits according to the target subscription plan information. The mobile phone is connected to the second subscription server through the WiFi/cellular network, and the mobile phone sends the purchase subscription information to the second subscription server through the APP. The second subscription server verifies the validity of the purchase to the first subscription server according to the purchase subscription information, determines that the purchase is successful when the verification is passed, sends the purchase subscription information to the subscription information storage server for storage, and sends the updating information of the subscription credits to the APP of the mobile phone. The subscription information storage server stores subscription credits of each user.

The user may manually enter the subscription operation instruction to the mobile phone, and the mobile phone performs the above-mentioned subscription operation process according to the subscription operation instruction.

The first subscription server, the second subscription server, and the subscription information storage server are all set up on the cloud server and are connected to each other through the network. The first subscription server may be an Apple/Google payment server (IAP service), and the subscription information storage server may be a gateway.

The purchase subscription information includes: identity of smart glasses of the user, subscription duration, subscription credits, and subscription items.

The credits may be tokens, and the consumption of the tokens is based on the use of the GAILLM service. The credits further may be a duration, and the consumption of the duration is based on the time spent using the GAILLM service. The credits further may be one-time or recurring weekly or monthly subscriptions, and the user is eligible to use the GAILLM service during the subscription period.

After the user obtains the permission to use the GAILLM service, the user speaks a voice command for using service, to request the use of the subscribed GAILLM service. The smart glasses 110 send the voice command for using service to the mobile phone. The mobile phone parses the voice command for using service, obtains a use service instruction contained in the voice command, and requests the use of the GAILLM service from the subscription information storage server. The subscription information storage server queries subscription credits of the user, requests the service(s) from the GAILLM when the subscription credits are available, and sends the obtained service content of the GAILLM to the mobile phone, so as to display the service content in the form of text or voice on the mobile phone. Alternatively, the mobile phone forwards the obtained service content of the GAILLM to the smart glasses 110, and the smart glasses 110 play the service content of the GAILLM by the voice.

As an example, FIG. 5 shows a user subscribing to the GAILLM service through the web browser of the smart terminal 120 such as a computer. When the smart terminal is the computer, the user logs into the web browser of the computer. The user sends a subscription instruction to the computer through manual input. The computer parses the voice subscription instruction, obtains the subscription operation instruction contained in the voice. The computer is connected to the first subscription server through the WiFi/cellular network. The computer obtains the subscription plan information from the first subscription server through the web browser, and displays the subscription plan information to the user by speech playback or displaying the text on the UI interface, so that the user selects a subscription plan. The computer obtains the information of the target subscription plan selected by the user through the voice or UI interface, and purchases the subscription credits according to the target subscription plan information. The first subscription server and the payment server are connected through the WiFi/cellular network, and the first subscription server sends the purchase subscription information to the payment server. The payment server verifies the validity of the purchase based on the purchase subscription information, determines that the purchase is successful when the verification is passed, sends the purchase subscription information to the subscription information storage server for storage (that is, stores subscription credits of each user in the subscription information storage server), and sends the updating information of the subscription credits to the web browser.

After the user obtains the permission to use the GAILLM service, the user speaks a voice command for using service, to request the use of the subscribed GAILLM service. The smart glasses 110 send the voice command for using service to the mobile phone. The mobile phone parses the voice command for using service, obtains a use service instruction contained in the voice command, and requests the use of the GAILLM service from the subscription information storage server. The subscription information storage server queries subscription credits of the user, requests the service(s) from the GAILLM when the subscription credits are available, and sends the obtained service content of the GAILLM to the mobile phone, so as to display the service content in the form of text or voice on the mobile phone. Alternatively, the mobile phone forwards the obtained service content of the GAILLM to the smart glasses 110, and the smart glasses 110 play the service content of the GAILLM by the voice.

Except for the above-mentioned scene where the user needs to obtain the permission to use the GAILLM service through the paid purchase, the user can also obtain the permission to use the GAILLM service for free by listening to an advertising content. The user does not need to purchase any subscription credits to use the GAILLM Service, but the user is required to listen to the advertising content in audio format on a regular basis through smart glasses, for example, when using the GAILLM service for the first time of one day, or after using a preset number of tokens or time, the permission to use the GAILLM service can be obtained by listening to the advertising content.

Optionally, in another embodiment of the present disclosure, the cloud server includes an advertisement server.

The smart terminal is further used to: when the user making the service request does not have the permission to use the GAILLM service, obtain an advertising content from the advertisement server, and play the advertising content, or forward the advertising content to the smart glasses 110 for playback; and after the advertising content is played, display the obtained service content corresponding to the service request to the user, or forward the service content to the smart glasses 110 for playback.

The smart glasses 110 is used to receive a speech of the advertising content sent by the smart terminal 120, and play the speech of the advertising content through the speaker.

The advertisement server is further used to: generate association information of the advertising content according to preset rules, and push the association information to the smart terminal 120 to display the association information on an interactive interface of the smart terminal 120 for the user to view.

After the smart glasses play the advertising content, the smart glasses will send a push notification message to the APP. The user can click on the push notification message to see more details about the advertising content, and the user can be further guided to purchase the products of interest associated with the advertising content.

Optionally, in another embodiment of the present disclosure, the cloud server further includes a historical information server, and the historical information server may be a gateway.

The advertisement server is used to: obtain historical information from the historical information server, determine and generate a targeted advertisement speech of the user according to the historical information, and send the targeted advertisement speech to the smart terminal 120. The historical information includes personal information of the user, and chat history information and command history information generated by the user using the GAILLM service.

The smart terminal 120 plays the targeted advertisement speech locally for the user to listen. Alternatively, the smart terminal 120 forwards the targeted advertisement speech to the smart glasses 110, and the smart glasses 110 play the targeted advertisement speech.

The chat history information and command history information generated by using GAILLM service, specifically, may be chat history information and command history information generated by making chat applications or speech command personal assistant applications. The targeted advertisement speech is the advertisement(s) corresponding to the content of personal interest to the user, which is obtained based on the historical information of the user, for example, if the user frequently uses the GAILLM service for music-related queries or speech commands, more music-related advertising content will be targeted pushed to the user.

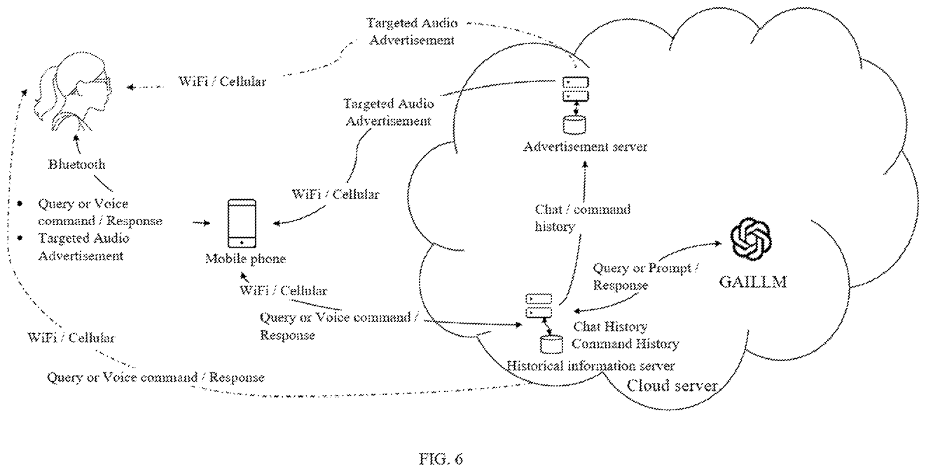

For an example of the advertising content, see FIG. 6, the GAILLM in FIG. 6 is set up on a cloud server, the smart glasses are connected to the phone through the Bluetooth, and the mobile phone is connected to the history information server through the WiFi/cellular network. The user speaks a speech, the smart glasses send the speech to the mobile phone. The mobile phone parses and obtains a service request to use the GAILLM service, determines whether the user has the permission to use the GAILLM service according to the identity information of the smart glasses, obtains the advertising content from the advertisement server when the user does not have the permission, and sends a service request to the history information server. The history information server requests the service from the GAILLM, receives the service content sent by the GAILLM, and sends the service content to the mobile phone. The mobile phone sends a notification of listening to the advertising content to the smart glasses, the user obtains the service permission after listening to the advertising content, and the mobile phone plays the service content or sends the service content to the smart glasses for playback.

The advertising content may be a targeted advertisement speech, and the advertisement server can push the targeted advertisement speech to the mobile phone. The historical information server stores historical information, and the historical information includes the personal information of the user, and the chat history information and command history information generated by the user using the GAILLM service. The advertisement server obtains the historical information from the historical information server, determines and generates the targeted advertisement speech of the user according to the historical information, and sends the targeted advertisement speech to the mobile phone.

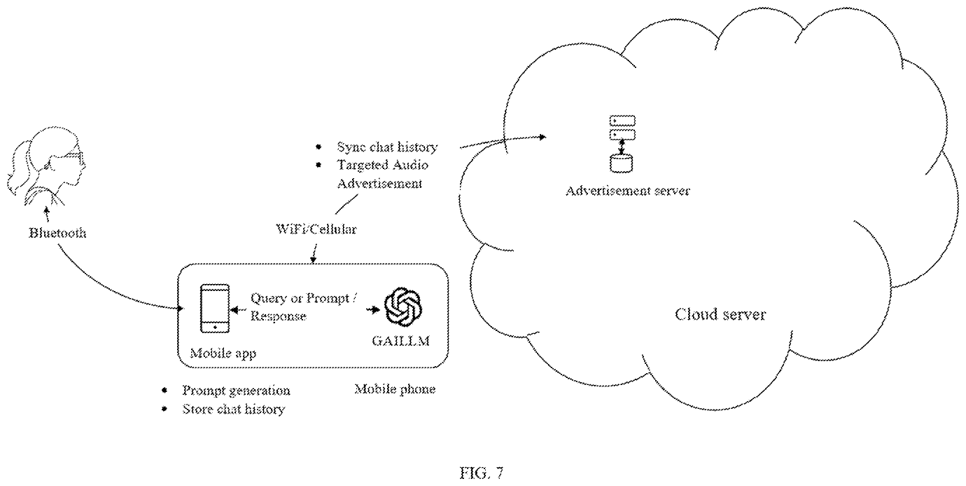

For another example of the advertising content, see FIG. 7, the GAILLM in FIG. 7 is set up in a mobile phone. The mobile phone communicates with the GAILLM through a built-in APP, the historical information is stored in the mobile phone, and the smart glasses are connected to the mobile phone through Bluetooth. The user speaks a speech, the smart glasses send the speech to the mobile phone. The mobile phone parses the speech and obtains a service request to use the GAILLM service, determines whether the user has the permission to use the GAILLM service according to the identity information of the smart glasses, obtains the advertising content from the advertisement server when the user does not have the permission, requests a service from the GAILLM, and receives the service content sent by the GAILLM. The mobile phone sends a notification of listening to the advertising content to the smart glasses, the user obtains the service permission after listening to the advertising content, and the mobile phone plays the service content or sends the service content to the smart glasses for playback.

An embodiment of the present disclosure further provides a smart terminal. The smart terminal includes: a non-transitory memory, a processor, and one or more computer programs stored in the non-transitory memory and executable on the processor. The one or more computer programs include instructions for implementing the following functions of the smart terminal, or performing the steps of the following method for obtaining a using permission of the GAILLM. Specifically, the smart terminal is used to: when a request for using a GAILLM service of a user is obtained, determine whether the user has a permission to use the GAILLM service according to subscription information corresponding to identity information of smart glasses of the user; in response to the user having the permission, allow the user to use the GAILLM service, and request a service(s) from the GAILLM according to the request of the user; and in response to the user not having the permission, notify the user to obtain the permission by performing a preset action(s).

The smart terminal and the smart glasses in the present embodiment are the smart terminal 120 and the smart glasses 110 shown in above-mentioned FIG. 1.

In the embodiment of the present disclosure, when the request for using the GAILLM service of the user is obtained, the smart terminal determines whether the user has the permission to use the GAILLM service according to the subscription information corresponding to the identity information of the smart glasses of the user. When the user has the permission, the smart terminal allows the user to use the GAILLM service. When the user does not have the permission, the smart terminal notifies the user to obtain the permission by performing the preset action(s). Accordingly, when a user requests to use the GAILLM service, the subscription status of the user to the GAILLM service can be quickly determined through the identity information of the smart glasses of the user, and a permission to use the GAILLM service is provided to the user or an obtaining manner of the permission is notified to the user according to the determining result, and thereby improving the convenience of providing the GAILLM service to the user.

Optionally, in another embodiment of the present disclosure, the smart terminal is further used to play a subscription service notification speech, and the subscription service notification speech is used to notify the user to obtain the permission to use the GAILLM service by purchasing a paid subscription.

Alternatively, the smart terminal is further used to play a notification speech for listening to an advertisement, and the notification speech for listening to the advertisement is used to notify the user to obtain the permission to use the GAILLM service for free by listening to an advertising content.

Optionally, in another embodiment of the present disclosure, the smart terminal is connected to the smart glasses. The smart terminal is further used to forward a subscription service notification speech to the smart glasses for playback, and the subscription service notification speech is used to notify the user to obtain the permission to use the GAILLM service by purchasing a paid subscription. Alternatively, the smart terminal is further used to forward a notification speech for listening to an advertisement to the smart glasses for playback, and the notification speech for listening to the advertisement is used to notify the user to obtain the permission to use the GAILLM service for free by listening to an advertising content.

Optionally, in another embodiment of the present disclosure, the smart terminal is used to obtain a subscription service request, and request a subscription for using the GAILLM service according to the subscription service request. The subscription service request is sent by the smart glasses according to a voice subscription instruction of the user.

Optionally, in another embodiment of the present disclosure, the smart terminal is connected to a cloud server, the GAILLM is set on the cloud server, the cloud server includes a subscription server. The smart terminal is used to: obtain a permission reminder message sent by the subscription server, and send the permission reminder message to the smart glasses for playback. The permission reminder message is used to remind the user that the permission to use the GAILLM service is about to be exhausted.

Optionally, in another embodiment of the present disclosure, the smart terminal is further used to: determine whether the user is requesting the GAILLM service for a first time by detecting an identity of the smart glasses of the user; when the user is requesting the GAILLM service for the first time, determine whether the user is never subscribed to the GAILLM service; when the user is never subscribed to the GAILLM service, send the notification speech for listening to the advertisement to the smart glasses for playback; in response to an action of the user to confirm to listen to an advertisement being detected, send the advertising content to the smart glasses for playback; in response to an action of the user to refuse to listen to the advertisement being detected, send the subscription service notification speech to the smart glasses for playback; when the user is not requesting the GAILLM service for the first time, determine whether the user is never subscribed to the GAILLM service or whether a permission of the subscribed GAILLM service is exhausted; and send the subscription service notification speech to the smart glasses for playback when the user is never subscribed to the GAILLM service or the permission of the subscribed GAILLM service is exhausted.

Optionally, in another embodiment of the present disclosure, the cloud server further includes a subscription information storage server. The smart terminal is used to: when a subscription instruction sent by the smart glasses is obtained, obtain subscription plan information and purchase subscription credits from the subscription server; and after the purchase is successful, send purchase subscription information to the subscription information storage server for storage, or store the purchase subscription information in the smart terminal.

Optionally, in another embodiment of the present disclosure, the subscription server includes a first subscription server. The smart terminal is further used to: obtain the subscription plan information from the first subscription server through an application program or a browser of the smart terminal, and display the subscription plan information to the user; and obtain target subscription plan information selected by the user, and purchase the subscription credits according to the target subscription plan information.

Optionally, in another embodiment of the present disclosure, the subscription server further includes a second subscription server. The smart terminal is further used to: send the purchase subscription information to the second subscription server through the application program, so that the second subscription server verifies validity of the purchase to the first subscription server according to the purchase subscription information, determines that the purchase is successful when the verification is passed, and sends the purchase subscription information to the subscription information storage server or the smart terminal for storage. The smart terminal is further used to obtain updating information of the subscription credits through the application program.

Optionally, in another embodiment of the present disclosure, the cloud server further includes a payment server. The smart terminal is further used to: send the purchase subscription information to the payment server through the browser, so that the payment server verifies whether the purchase is successful, determines that the purchase is successful when the verification is passed, and sends the purchase subscription information to the subscription information storage server or the smart terminal for storage.

Optionally, in another embodiment of the present disclosure, the smart terminal is further used to: obtain a service request sent by the user through the smart glasses, and send a service request to the subscription information storage server to trigger the subscription information storage server to request a service content from the GAILLM; and receive the service content returned by the subscription information storage server, and display the service content to the user.

Optionally, in another embodiment of the present disclosure, the GAILLM is set on the smart terminal. The smart terminal is further used to obtain a speech sent by the user through the smart glasses, parse the speech, and display the service content to the user when the speech includes a subscription operation instruction.

Optionally, in another embodiment of the present disclosure, the cloud server further includes an advertisement server and a historical information server. The smart terminal is further used to receive a targeted advertisement speech sent by the advertisement server, and play the targeted advertisement speech, or send the targeted advertisement speech to the smart glasses for playback. The advertisement server obtains historical information from the historical information server, and generates the targeted advertisement speech according to the historical information. The historical information includes personal information of the user, chat history information and command history information. The chat history information and the command history information are generated by the user using the GAILLM service.

Optionally, in another embodiment of the present disclosure, the smart terminal is further used to: when the user making the service request does not have the permission to use the GAILLM service, obtain an advertising content from the advertisement server, and play the advertising content or forward the advertising content to the smart glasses for playback; and after the advertising content is played, display the obtained service content corresponding to the service request to the user or forward the service content to the smart glasses for playback.

Optionally, in another embodiment of the present disclosure, the smart terminal is further used to obtain association information of the advertising content sent by the advertisement server, and display the association information on an interactive interface for the user to view.

The smart terminal in the embodiments of the present disclosure, that is, the smart terminal 120 in the above-mentioned embodiments, the details not exhausted in the present embodiments may also refer to the relevant descriptions in the above-mentioned embodiments of the processing system, and will not be repeated herein.

In the embodiments of the present application, when the request for using the GAILLM service of the user is obtained, the smart terminal determines whether the user has the permission to use the GAILLM service according to the subscription information corresponding to the identity information of the smart glasses of the user. When the user has the permission, the smart terminal allows the user to use the GAILLM service. When the user does not have the permission, the smart terminal notifies the user to obtain the permission by performing the preset action(s). Accordingly, when a user requests to use the GAILLM service, the subscription status of the user to the GAILLM service can be quickly determined through the identity information of the smart glasses of the user, and a permission to use the GAILLM service is provided to the user or a obtaining manner of the permission is notified to the user according to the determining result, and thereby improving the convenience of providing the GAILLM service to the user, and improving the speed and efficiency of obtaining the service permission.

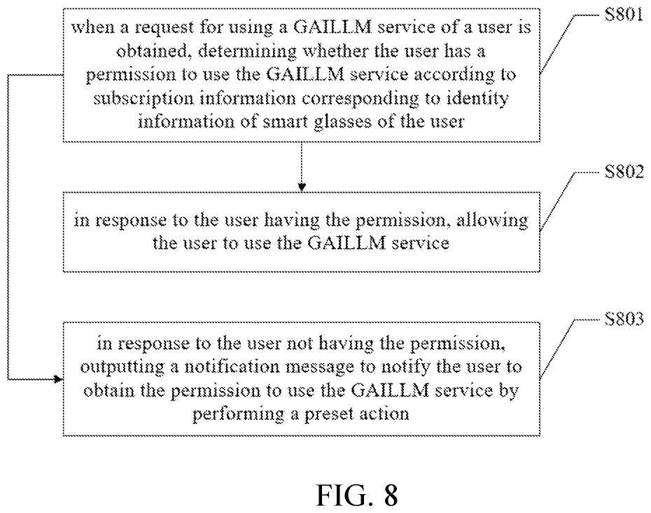

An embodiment of the present disclosure further provides a method for obtaining a using permission of a generative artificial intelligence large language model (GAILLM). FIG. 8 is a flow diagram of the method for obtaining the using permission of the GAILLM according to one embodiment, and the method is applied to a processing system based on the GAILLM. The processing system includes smart glasses and a smart terminal connected to the smart glasses, and the GAILLM is set on the smart terminal. The processing system further includes a cloud server connected to the smart terminal. The GAILLM may be set on the cloud server or the smart terminal. The smart terminal includes, but is not limited to, a smartphone, and a smart watch. The method includes the following steps:
S801, when a request for using a GAILLM service of a user is obtained, determining whether the user has a permission to use the GAILLM service according to subscription information corresponding to identity information of smart glasses of the user;

The identity information of the smart glasses may be a unique ID (Identity), the form of the identity information may be numbers, letters, or other marking information that can uniquely identify the smart glasses, and may be set before the smart glasses leave the factory, or may be customized by the user.

The subscription information refers to the information related to the user subscribing to the GAILLM service, which corresponds to the identity information of the smart glasses.

The GAILLM may be, but is not limited to: ChatGPT of Open AI, Bard of Google, and other models with similar functions. Use of the GAILLM Service includes, but is not limited to, when making chat applications or speech command personal assistant applications, requesting to GAILLM and obtaining a service content.
S802, in response to the user having the permission, allowing the user to use the GAILLM service; and
S803, in response to the user not having the permission, outputting a notification message to notify the user to obtain the permission to use the GAILLM service by performing a preset action.

The preset action may be purchasing the permission for using the GAILLM service, or listening to an advertising content. When the user is a new user, that is, a user who requests to use the GAILLM service for the first time, the new user can also be assigned a certain permission to use the GAILLM service, and after the certain permission is exhausted, the permission can be obtained by the above-mentioned actions of purchasing the permission or listening to the advertising content.

In the embodiments of the present disclosure, when a request for using a GAILLM service of a user is obtained, the step of determining whether the user has a permission to use the GAILLM service according to subscription information corresponding to identity information of smart glasses of the user is performed. When the user has the permission, the user is allowed to use the GAILLM service, and when the user does not have the permission, a notification message is outputted to notify the user to obtain the permission by performing a preset action. Accordingly, when a user requests to use the GAILLM service, the subscription status of the user to the GAILLM service can be quickly determined through the identity information of the smart glasses of the user, and a permission to use the GAILLM service is provided to the user or an obtaining manner of the permission is notified to the user according to the determining result, and thereby improving the convenience of providing the GAILLM service to the user.

Optionally, in other embodiments of the present disclosure, outputting the notification message to notify the user to obtain the permission to use the GAILLM service by performing the preset action of the step S803 including:
playing, by the smart terminal, a subscription service notification speech, wherein the subscription service notification speech is used to notify the user to obtain the permission by purchasing a paid subscription; or
playing, by the smart terminal, a notification speech for listening to an advertisement, wherein the notification speech for listening to the advertisement is used to notify the user to obtain the permission to use the GAILLM service for free by listening to an advertising content.

Optionally, in other embodiments of the present disclosure, outputting the notification message to notify the user to obtain the permission to use the GAILLM service by performing the preset action of the step S803 including:
forwarding, by the smart terminal, a subscription service notification speech to the smart glasses for playback, wherein the subscription service notification speech is used to notify the user to obtain the permission to use the GAILLM service by purchasing a paid subscription; or
forwarding, by the smart terminal, a notification speech for listening to an advertisement to the smart glasses for playback, wherein the notification speech for listening to the advertisement is used to notify the user to obtain the permission to use the GAILLM service for free by listening to an advertising content.

Optionally, in other embodiments of the present disclosure, the method further includes:
determining whether the user is requesting the GAILLM service for a first time by detecting an identity of the smart glasses of the user; when the user is requesting the GAILLM service for the first time, determining whether the user is never subscribed to the GAILLM service, and when the user is never subscribed to the GAILLM service, sending the notification speech for listening to the advertisement to the smart glasses for playback; in response to an action of the user to confirm to listen to an advertisement being detected, sending the advertising content to the smart glasses for playback; in response to an action of the user to refuse to listen to the advertisement being detected, sending the subscription service notification speech to the smart glasses for playback; when the user is not requesting the GAILLM service for the first time, determining whether the user is never subscribed to the GAILLM service or whether a permission of the subscribed GAILLM service is exhausted; and when the user is never subscribed to the GAILLM service or the permission of the subscribed GAILLM service is exhausted, sending the subscription service notification speech to the smart glasses for playback.

Optionally, in other embodiments of the present disclosure, after the step S803 of in response to the user not having the permission, outputting the notification message to notify the user to obtain the permission to use the GAILLM service by performing the preset action, the method further includes:
obtaining, by the smart glasses, a voice subscription instruction of the user, and sending a subscription service request to the smart terminal according to the voice subscription instruction. The smart terminal is used to request a subscription for using the GAILLM service according to the subscription service request.

Optionally, in other embodiments of the present disclosure, the processing system further includes a cloud server connected to the smart terminal, the GAILLM is set on the cloud server, and the cloud server further includes a subscription server. The method further includes: sending, by the subscription server, a permission reminder message to the smart terminal.

The permission reminder message is used to remind the user that the permission to use the GAILLM service is about to be exhausted.

The smart terminal sends the permission reminder message to the smart glasses.

The smart glasses play the permission reminder message by the voice.

Optionally, in other embodiments of the present disclosure, the cloud server further includes a subscription information storage server.

The smart glasses obtain a speech of the user, and forward the speech to the smart terminal.

When the speech includes a subscription operation instruction, the smart terminal obtains subscription plan information and purchase subscription credits from the subscription server, and after the purchase is successful, the smart terminal sends purchase subscription information to the subscription information storage server for storage, or stores the purchase subscription information in the smart terminal.

Optionally, in other embodiments of the present disclosure, the subscription server includes a first subscription server.

The smart terminal obtains the subscription plan information from the first subscription server through an application program or a browser of the smart terminal, and displays the subscription plan information to the user.

The smart terminal obtains target subscription plan information selected by the user, and purchases the subscription credits according to the target subscription plan information.

Optionally, in other embodiments of the present disclosure, the subscription server further includes a second subscription server.

The smart terminal sends the purchase subscription information to the second subscription server through the application program.

The second subscription server verifies validity of the purchase to the first subscription server according to the purchase subscription information, determines that the purchase is successful when the verification is passed, sends the purchase subscription information to the subscription information storage server or the smart terminal for storage, and sends updating information of the subscription credits to the application program of the smart terminal.

Optionally, in other embodiments of the present disclosure, the cloud server further includes a payment server.

The smart terminal sends the purchase subscription information to the payment server through the browser, so that the payment server verifies whether the purchase is successful, determines that the purchase is successful when the verification is passed, and sends the purchase subscription information to the subscription information storage server or the smart terminal for storage.

Optionally, in other embodiments of the present disclosure, the smart terminal obtains a service request sent by the user through the smart glasses, and sends a service request to the subscription information storage server to trigger the subscription information storage server to request a service content from the GAILLM. The smart terminal receives the service content returned by the subscription information storage server, and displays the service content to the user.

Optionally, in other embodiments of the present disclosure, the GAILLM is set on the smart terminal.

The smart terminal obtains a speech sent by the user through the smart glasses, parses the speech, and when the speech includes a subscription operation instruction, requests a service content from the GAILLM and displays the service content to the user.

Optionally, in other embodiments of the present disclosure, the cloud server further includes an advertisement server and a historical information server.

The advertisement server obtains historical information from the historical information server. The historical information includes personal information of the user, and chat history information and command history information generated by the user using the GAILLM service. The advertisement server determines and generates a targeted advertisement speech of the user according to the historical information, and sends the targeted advertisement speech to the smart terminal.

Optionally, in other embodiments of the present disclosure, when the smart terminal detects that the user making the service request does not have the permission to use the GAILLM service, the smart terminal obtains an advertising content from the advertisement server, and plays the advertising content, or forwards the advertising content to the smart glasses for playback. After the advertising content is played, the smart terminal displays the obtained service content corresponding to the service request to the user, or forwards the service content to the smart glasses for playback.

Optionally, in other embodiments of the present disclosure, the advertisement server generates association information of the advertising content according to preset rule(s) and sends the association information to the smart terminal, so as to display the association information on an interactive interface of the terminal for the user to view.

Optionally, in other embodiments of the present disclosure, free credits with a preset amount or a preset using period are configured in an identity of smart glasses using the GAILLM for the first time, and when an amount of the free credits is less than a preset value or the free credits are expired, a subscription service notification speech and/or a waiting voice notification is played.

The subscription service notification speech is used to notify the user to obtain the permission to use the GAILLM service by purchasing a paid subscription. The waiting voice notification is used to remind the user to wait for a next preset configuration cycle to obtain free credits for the next preset configuration cycle.

In the above-mentioned embodiments, the smart glasses, the smart terminal and the cloud server are the smart glasses 110, the smart terminal 120 and the cloud server 130 in the above-mentioned embodiments shown in FIG. 1. Details not exhausted in the present embodiment may also refer to the relevant descriptions in the above-mentioned embodiments shown in FIGS. 1 to 8, which will not be repeated herein.

In the embodiments of the present application, when a request for using a GAILLM service of a user is obtained, the step of determining whether the user has a permission to use the GAILLM service according to subscription information corresponding to identity information of smart glasses of the user is performed. When the user has the permission, the user is allowed to use the GAILLM service, and when the user does not have the permission, a notification message is outputted to notify the user to obtain the permission by performing a preset action. Accordingly, when a user requests to use the GAILLM service, the subscription status of the user to the GAILLM service can be quickly determined through the identity information of the smart glasses of the user, and a permission to use the GAILLM service is provided to the user or a obtaining manner of the permission is notified to the user according to the determining result, and thereby improving the convenience of providing the GAILLM service to the user, and improving the speed and efficiency of obtaining the service permission.

The present disclosure further provides a non-transitory computer-readable storage medium, which can be set in the smart glasses or smart wearable device in the above-mentioned embodiments, and may be the memory 116 in the embodiment shown in FIG. 2. The computer-readable storage medium stores one or more computer programs. When the one or more programs are executed by the processor, all or part of the method for obtaining the using permission of the GAILLM, in the above-mentioned embodiment(s) is performed. Further, the computer-readable storage medium may also be a USB flash drive, a mobile hard disk, a read-only memory (ROM), a Random Access Memory (RAM), a disk, or a CD-ROM, or any medium capable of storing program code.

It should be understood that in the above-described embodiments of the present disclosure, the above-mentioned processing system based on the GAILLM, the method for obtaining the using permission of the GAILLM, and the smart terminal may be implemented in other manners. For example, multiple units/modules may be combined or be integrated into another system, or some of the features may be ignored or not performed. In addition, the above-mentioned mutual coupling/connection may be direct coupling/connection or communication connection, and may also be indirect coupling/connection or communication connection through some interfaces/devices, and may also be electrical, mechanical or in other forms.

It should be noted that for the various method embodiments described above, for the sake of simplicity, they are described as a series of action combinations. However, those skilled in the art should understand that the present disclosure is not limited by the order of the described actions, as certain steps can be performed in a different order or simultaneously. Additionally, it should be understood that the embodiments described in this invention are preferred embodiments, and the actions and modules involved are not necessarily required for the present disclosure.

In the above-mentioned embodiments, the descriptions of each embodiment have different focuses. For portions not described in a particular embodiment, reference can be made to relevant descriptions in other embodiments.

The above is a description of the processing system based on the GAILLM, the method for obtaining the using permission of the GAILLM, and the smart terminal provided by the present disclosure. Those skilled in the art should understand that based on the embodiments of the present disclosure, there may be changes in specific implementation methods and application scope. Therefore, the content of this specification should not be construed as limiting the present disclosure.

What is claimed is:

1. A processing system based on a generative artificial intelligence large language model (GAILLM), comprising a smart terminal configured to:
when a request for using a GAILLM service of a user is obtained, determine whether the user has a permission to use the GAILLM service according to subscription information corresponding to identity information of smart glasses of the user;
in response to the user having the permission, allow the user to use the GAILLM service; and
in response to the user not having the permission, output a notification message to notify the user to obtain the permission by performing a preset action.

2. The processing system of claim 1, wherein the smart terminal is further configured to:
play a subscription service notification speech, wherein the subscription service notification speech is configured to notify the user to obtain the permission by purchasing a paid subscription; or
play a notification speech for listening to an advertisement, wherein the notification speech for listening to the advertisement is configured to notify the user to obtain the permission for free by listening to an advertising content.

3. The processing system of claim 1, wherein the processing system further comprises the smart glasses connected to the smart terminal;
the smart terminal is further configured to:
forward a subscription service notification speech to the smart glasses, wherein the subscription service notification speech is configured to notify the user to obtain the permission by purchasing a paid subscription; or
forward a notification speech for listening to an advertisement to the smart glasses, the notification speech for listening to the advertisement is configured to notify the user to obtain the permission for free by listening to an advertising content; and
the smart glasses are configured to play the subscription service notification speech or the notification speech for listening to the advertisement.

4. The processing system of claim 3, wherein the smart glasses are further configured to obtain a voice subscription instruction of the user, and send a subscription service request to the smart terminal according to the voice subscription instruction; and
the smart terminal is further configured to request a subscription for using the GAILLM service according to the subscription service request.

5. The processing system of claim 4, wherein the processing system further comprises a cloud server connected to the smart terminal, the GAILLM is set on the cloud server, and the cloud server comprises a subscription server;
the subscription server is configured to send a permission reminder message to the smart terminal, wherein the permission reminder message is configured to remind the user that the permission to use the GAILLM service is about to be exhausted;
the smart terminal is further configured to send the permission reminder message to the smart glasses; and
the smart glasses are further configured to play the permission reminder message by voice.

6. The processing system of claim 2, wherein the smart terminal is further configured to:
determine whether the user is requesting the GAILLM service for a first time by detecting an identity of the smart glasses of the user;
when the user is requesting the GAILLM service for the first time, determine whether the user is never subscribed to the GAILLM service, and when the user is never subscribed to the GAILLM service, send the notification speech for listening to the advertisement to the smart glasses for playback;
in response to an action of the user to confirm to listen to an advertisement being detected, send the advertising content to the smart glasses for playback;
in response to an action of the user to refuse to listen to the advertisement being detected, send the subscription service notification speech to the smart glasses for playback; and
when the user is not requesting the GAILLM service for the first time, determine whether the user is never subscribed to the GAILLM service or whether a permission of the subscribed GAILLM service is exhausted, and send the subscription service notification speech to the smart glasses for playback when the user is never subscribed to the GAILLM service or the permission of the subscribed GAILLM service is exhausted.

7. The processing system of claim 5, wherein the cloud server further comprises a subscription information storage server;
the smart glasses are further configured to obtain a speech of the user, and forward the speech to the smart terminal; and
the smart terminal is further configured to obtain subscription plan information and purchase subscription credits from the subscription server when the speech comprises a subscription operation instruction, and after the purchase is successful, send purchase subscription information to the subscription information storage server for storage, or store the purchase subscription information in the smart terminal.

8. The processing system of claim 7, wherein the subscription server comprises a first subscription server;
the smart terminal is further configured to:
obtain the subscription plan information from the first subscription server through an application program or a browser of the smart terminal, and display the subscription plan information to the user; and
obtain target subscription plan information selected by the user, and purchase the subscription credits according to the target subscription plan information.

9. The processing system of claim 8, wherein the subscription server further comprises a second subscription server;
the smart terminal is further configured to send the purchase subscription information to the second subscription server through the application program; and
the second subscription server is configured to:
verify validity of the purchase to the first subscription server according to the purchase subscription information;
determine that the purchase is successful when the verification is passed, and send the purchase subscription information to the subscription information storage server or the smart terminal for storage; and
send updating information of the subscription credits to the application program of the smart terminal.

10. The processing system of claim 8, wherein the cloud server further comprises a payment server; and
the smart terminal is further configured to send the purchase subscription information to the payment server through the browser, so that the payment server verifies whether the purchase is successful, determines that the purchase is successful when the verification is passed, and sends the purchase subscription information to the subscription information storage server or the smart terminal for storage.

11. The processing system of claim 7, wherein the smart terminal is further configured to:
obtain a service request sent by the user through the smart glasses, and send a service request to the subscription information storage server to trigger the subscription information storage server to request a service content from the GAILLM; and
receive the service content returned by the subscription information storage server, and display the service content to the user.

12. The processing system of claim 2, wherein the GAILLM is set on the smart terminal, and the smart terminal is further configured to:
obtain a speech sent by the user through the smart glasses, and parse the speech; and
request a service content from the GAILLM when the speech comprises a subscription operation instruction, and display the service content to the user.

13. The processing system of claim 11, wherein the cloud server further comprises an advertisement server and a historical information server, and the advertisement server is configured to:
obtain historical information from the historical information server, wherein the historical information comprises personal information of the user, and chat history information and command history information generated by the user using the GAILLM service; and
determine and generate a targeted advertisement speech of the user according to the historical information, and send the targeted advertisement speech to the smart terminal.

14. The processing system of claim 13, wherein the smart terminal is further configured to:
when the user making the service request does not have the permission to use the GAILLM service, obtain an advertising content from the advertisement server, and play the advertising content, or forward the advertising content to the smart glasses for playback; and
after the advertising content is played, display the obtained service content corresponding to the service request to the user, or forward the service content to the smart glasses for playback.

15. The processing system of claim 14, wherein the advertisement server is further configured to generate association information of the advertising content according to preset rules, and send the association information to the smart terminal to display the association information on an interactive interface of the smart terminal for the user to view.

16. The processing system of claim 1, wherein the smart terminal is further configured to:
configure free credits with a preset amount or a preset using period for an identity of smart glasses using the GAILLM for a first time; and
play a subscription service notification speech and/or a waiting voice notification when an amount of the free credits is less than a preset value or the free credits are expired;
wherein the subscription service notification speech is configured to notify the user to obtain the permission by purchasing a paid subscription, and the waiting voice notification is configured to remind the user to wait for a next preset configuration cycle to obtain free credits for the next preset configuration cycle.

17. A smart terminal, comprising:
a non-transitory memory;
a processor; and
one or more computer programs stored in the non-transitory memory and executable on the processor, wherein the one or more computer programs comprise instructions to:
when a request for using a GAILLM service of a user is obtained, determine whether the user has a permission to use the GAILLM service according to subscription information corresponding to identity information of smart glasses of the user;
in response to the user having the permission, allow the user to use the GAILLM service; and
in response to the user not having the permission, output a notification message to notify the user to obtain the permission by performing a preset action.

18. The smart terminal of claim 17, wherein the instructions are further configured to:
play a subscription service notification speech, wherein the subscription service notification speech is configured to notify the user to obtain the permission by purchasing a paid subscription; or
play a notification speech for listening to an advertisement, wherein the notification speech for listening to the advertisement is configured to notify the user to obtain the permission for free by listening to an advertising content.

19. The smart terminal of claim 17, wherein the smart terminal is connected to the smart glasses, and the instructions are further configured to:
forward a subscription service notification speech to the smart glasses for playback, wherein the subscription service notification speech is configured to notify the user to obtain the permission by purchasing a paid subscription; or
forward a notification speech for listening to an advertisement to the smart glasses for playback, wherein the notification speech for listening to the advertisement is configured to notify the user to obtain the permission for free by listening to an advertising content.

20. The smart terminal of claim 19, wherein the instructions are further configured to obtain a subscription service request sent by the smart glasses according to a voice subscription instruction of the user, and request a subscription for using the GAILLM service according to the subscription service request.

21. The smart terminal of claim 20, wherein the smart terminal is connected to a cloud server, the GAILLM is set on the cloud server, the cloud server comprises a subscription server, and the instructions are further configured to:
obtain a permission reminder message sent by the subscription server; and
send the permission reminder message to the smart glasses for playback, wherein the permission reminder message is configured to remind the user that the permission to use the GAILLM service is about to be exhausted.

22. The smart terminal of claim 18, wherein the instructions are further configured to:
determine whether the user is requesting the GAILLM service for a first time by detecting an identity of the smart glasses of the user;
when the user is requesting the GAILLM service for the first time, determine whether the user is never subscribed to the GAILLM service, and when the user is never subscribed to the GAILLM service, send the notification speech for listening to the advertisement to the smart glasses for playback;
in response to an action of the user to confirm to listen to an advertisement being detected, send the advertising content to the smart glasses for playback;
in response to an action of the user to refuse to listen to the advertisement being detected, send the subscription service notification speech to the smart glasses for playback; and
when the user is not requesting the GAILLM service for the first time, determine whether the user is never subscribed to the GAILLM service or whether a permission of the subscribed GAILLM service is exhausted, and send the subscription service notification speech to the smart glasses for playback when the user is never subscribed to the GAILLM service or the permission of the subscribed GAILLM service is exhausted.

23. The smart terminal of claim 21, wherein the cloud server further comprises a subscription information storage server; and
the instructions are further configured to:
obtain subscription plan information and purchase subscription credits from the subscription server when a subscription instruction sent by the smart glasses is obtained; and
after the purchase is successful, send purchase subscription information to the subscription information storage server for storage, or store the purchase subscription information in the smart terminal.

24. The smart terminal of claim 23, wherein the subscription server comprises a first subscription server; and
the instructions are further configured to:
obtain the subscription plan information from the first subscription server through an application program or a browser of the smart terminal, and display the subscription plan information to the user; and
obtain target subscription plan information selected by the user, and purchase the subscription credits according to the target subscription plan information.

25. The smart terminal of claim 24, wherein the subscription server further comprises a second subscription server;
the instructions are further configured to send the purchase subscription information to the second subscription server through the application program, so that the second subscription server verifies validity of the purchase to the first subscription server according to the purchase subscription information, determines that the purchase is successful when the verification is passed, and sends the purchase subscription information to the subscription information storage server or the smart terminal for storage; and
the instructions are further configured to obtain updating information of the subscription credits through the application program.

26. The smart terminal of claim 24, wherein the cloud server further comprises a payment server; and
the instructions are further configured to send the purchase subscription information to the payment server through the browser, so that the payment server verifies whether the purchase is successful, determines that the purchase is successful when the verification is passed, and sends the purchase subscription information to the subscription information storage server or the smart terminal for storage.

27. The smart terminal of claim 23, wherein the instructions are further configured to:
obtain a service request sent by the user through the smart glasses, and send a service request to the subscription information storage server to trigger the subscription information storage server to request a service content from the GAILLM; and
receive the service content returned by the subscription information storage server, and display the service content to the user.

28. The smart terminal of claim 19, wherein the GAILLM is set on the smart terminal; and
the instructions are further configured to obtain a speech sent by the user through the smart glasses, parse the speech, and display the service content to the user when the speech comprises a subscription operation instruction.

29. The smart terminal of claim 27, wherein the cloud server further comprises an advertisement server and a historical information server; and
the instructions are further configured to receive a targeted advertisement speech sent by the advertisement server, and play the targeted advertisement speech, or send the targeted advertisement speech to the smart glasses for playback, wherein the advertisement server obtains historical information from the historical information server, and generates the targeted advertisement speech according to the historical information, and wherein the historical information comprises personal information of the user, and chat history information and command history information generated by the user using the GAILLM service.

30. The smart terminal of claim 29, wherein the instructions are further configured to:
when the user making the service request does not have the permission to use the GAILLM service, obtain an advertising content from the advertisement server, and play the advertising content, or forward the advertising content to the smart glasses for playback; and
after the advertising content is played, display the obtained service content corresponding to the service request to the user, or forward the service content to the smart glasses for playback.

31. The smart terminal of claim 30, wherein the instructions are further configured to obtain association information of the advertising content sent by the advertisement server, and display the association information on an interactive interface for the user to view.

32. A computer-implemented method for obtaining a using permission of a generative artificial intelligence large language model (GAILLM), applied to a smart terminal, comprising:
when a request for using a GAILLM service of a user is obtained, determining whether the user has a permission to use the GAILLM service according to subscription information corresponding to identity information of smart glasses of the user;
in response to the user having the permission, allowing the user to use the GAILLM service; and
in response to the user not having the permission, outputting a notification message to notify the user to obtain the permission by performing a preset action.

33. The method of claim 32, wherein the step of outputting the notification message to notify the user to obtain the permission by performing the preset action comprising:
playing a subscription service notification speech, wherein the subscription service notification speech is configured to notify the user to obtain the permission by purchasing a paid subscription; or
playing a notification speech for listening to an advertisement, wherein the notification speech for listening to the advertisement is configured to notify the user to obtain the permission for free by listening to an advertising content.

34. The method of claim 32, wherein the step of outputting the notification message to notify the user to obtain the permission by performing the preset action comprising:
forwarding a subscription service notification speech to the smart glasses for playback, wherein the subscription service notification speech is configured to notify the user to obtain the permission by purchasing a paid subscription; or
forwarding a notification speech for listening to an advertisement to the smart glasses for playback, wherein the notification speech for listening to the advertisement is configured to notify the user to obtain the permission for free by listening to an advertising content.

35. The method of claim 33, further comprising:
determining whether the user is requesting the GAILLM service for a first time by detecting an identity of the smart glasses of the user;
when the user is requesting the GAILLM service for the first time, determining whether the user is never subscribed to the GAILLM service, and when the user is never subscribed to the GAILLM service, sending the notification speech for listening to the advertisement to the smart glasses for playback;
in response to an action of the user to confirm to listen to an advertisement being detected, sending the advertising content to the smart glasses for playback;
in response to an action of the user to refuse to listen to the advertisement being detected, sending the subscription service notification speech to the smart glasses for playback; and
when the user is not requesting the GAILLM service for the first time, determining whether the user is never subscribed to the GAILLM service or whether a permission of the subscribed GAILLM service is exhausted, and sending the subscription service notification speech to the smart glasses for playback when the user is never subscribed to the GAILLM service or the permission of the subscribed GAILLM service is exhausted.
